(19) United States
(12) Patent Application Publication
(10) Pub. No.: US 2026/0147232 A1
(43) Pub. Date: May 28, 2026

(54) HYBRID PLASMONIC WAVEGUIDES

(71) Applicant: GlobalFoundries U.S. Inc., Malta, NY (US)

(72) Inventors: Yusheng Bian, Ballston Lake, NY (US); Kenneth J. Giewont, Hopewell Junction, NY (US)

(21) Appl. No.: 18/956,260

(22) Filed: Nov. 22, 2024

(51) Int. Cl. G02F 1/035

(52) U.S. Cl. CPC G02F 1/035; G02F 2201/06; G02F 2202/20; G02F 2203/10

(57) ABSTRACT

Structures for a photonic chip that include a waveguide and methods of forming such structures. The structure comprises a first waveguide core, a second waveguide core adjacent to the first waveguide core, and a first layer between the first waveguide core and the second waveguide core. The structure further comprises a second layer adjacent to the first waveguide core, and a third layer adjacent to the second waveguide core. The first layer comprises an electro-optic material, and the second and third layers comprise a metal.

### BACKGROUND

This disclosure relates to photonic chips and, more specifically, to structures for a photonic chip that include a waveguide and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

Waveguide cores are used on the photonic chip as building blocks to construct photonic components and as optical communication paths to connect the photonic components. Waveguides include lower-index cladding that surrounds the waveguide core to provide a contrast in refractive index for confining and guiding light on the photonic chip. Conventional waveguides may suffer from low optical confinement and high propagation loss.

Improved structures for a photonic chip that include a waveguide and methods of forming such structures are needed.

### SUMMARY

In an embodiment of the invention, a structure for a photonic chip is provided. The structure comprises a first waveguide core, a second waveguide core adjacent to the first waveguide core, and a first layer between the first waveguide core and the second waveguide core. The structure further comprises a second layer adjacent to the first waveguide core, and a third layer adjacent to the second waveguide core. The first layer comprises an electro-optic material, and the second and third layers comprise a metal.

In an embodiment of the invention, a structure for a photonic chip is provided. The structure comprises a first layer and a second layer adjacent to the first layer. The structure further comprises a third layer between the first layer and the second layer. The first layer and the second layer comprise a metal, the third layer comprises an electro-optic material, and the third layer has respective non-contacting relationships with the first layer and the second layer.

In an embodiment of the invention, a method of forming a structure for a photonic chip is provided. The method comprises forming a first waveguide core and a second waveguide core adjacent to the first waveguide core, and forming a first layer between the first waveguide core and the second waveguide core. The method further comprises forming a second layer adjacent to the first waveguide core and a third layer adjacent to the second waveguide core. The first layer comprises an electro-optic material, and the second and third layers comprise a metal.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of the structure at a fabrication stage of the processing method subsequent to FIGS. 2, 2A.

FIG. 4 is a cross-sectional view of a structure in accordance with alternative embodiments of the invention.

FIGS. 5, 5A are cross-sectional views of structures in accordance with alternative embodiments of the invention.

FIG. 6 is a top view of a structure in accordance with alternative embodiments of the invention.

FIG. 7 is a top view of a structure in accordance with alternative embodiments of the invention.

FIG. 8 is a top view of a structure in accordance with alternative embodiments of the invention.

FIG. 9 is a cross-sectional view of a structure in accordance with alternative embodiments of the invention.

FIG. 10 is a cross-sectional view of a structure in accordance with alternative embodiments of the invention.

### DETAILED DESCRIPTION

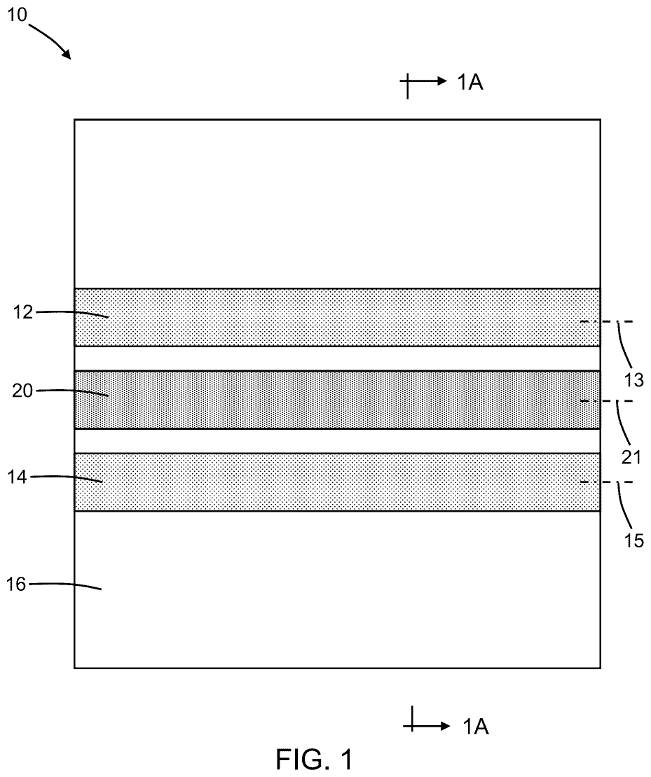

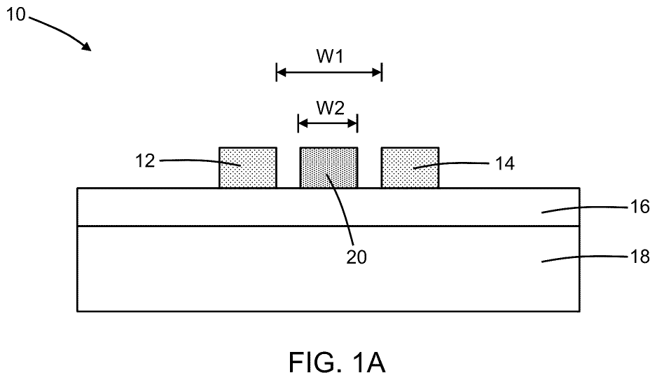

With reference to FIGS. 1, 1A and in accordance with embodiments of the invention, a structure 10 for a photonic chip includes a waveguide core 12 and a waveguide core 14 that is positioned adjacent to the waveguide core 12 in a lateral direction. The waveguide cores 12, 14 are positioned on, and above, a dielectric layer 16 and a semiconductor substrate 18. In an embodiment, the dielectric layer 16 may be comprised of a dielectric material, such as silicon dioxide, and the semiconductor substrate 18 may be comprised of a semiconductor material, such as single-crystal silicon. In an embodiment, the dielectric layer 16 may be a buried oxide layer of a silicon-on-insulator substrate. The dielectric layer 16 may provide low-index and electrically-insulating cladding that separates the waveguide cores 12, 14 from the semiconductor substrate 18.

The waveguide cores 12, 14 may provide a slotted waveguide structure in which the waveguide core 12 is spaced in a lateral direction from the waveguide core 14 by a gap having a width dimension W1. The waveguide core 12 may extend lengthwise along a longitudinal axis 13 and the waveguide core 14 may extend lengthwise along a longitudinal axis 15.

In an embodiment, the waveguide cores 12, 14 may be comprised of a material having a refractive index that is greater than the refractive index of silicon dioxide. In an embodiment, the waveguide cores 12, 14 may be comprised of a semiconductor material, such as single-crystal silicon, amorphous silicon, or polysilicon. In an alternative embodiment, the waveguide cores 12, 14 may be comprised of a dielectric material, such as silicon nitride, silicon oxynitride, or aluminum nitride. In alternative embodiments, other materials, such as a III-V compound semiconductor, may be used to form the waveguide cores 12, 14.

In an embodiment, the waveguide cores 12, 14 may be formed by patterning a layer comprised of their constituent material with lithography and etching processes. In an embodiment, an etch mask may be formed by a lithography process over the layer, and unmasked sections of the layer may be etched and removed with an etching process. In an embodiment, the waveguide cores 12, 14 may be formed by patterning the semiconductor material (e.g., single-crystal silicon) of the device layer of a silicon-on-insulator substrate. In an embodiment, the waveguide cores 12, 14 may be formed by patterning a deposited layer comprised of its constituent material (e.g., polysilicon or silicon nitride). In an embodiment, a slab layer may connect a lower portion of the waveguide core 12 to a lower portion of the waveguide core 14.

A layer 20 may be formed in the gap between the waveguide core 12 and the waveguide core 14. The layer 20 may be positioned between a portion of the waveguide core 12 and a portion of the waveguide core 14. In an embodiment, the layer 20 may be comprised of an electro-optic material that exhibits an electric-field-induced Pockels effect in which the refractive index varies in proportional to the strength of an applied electric field according to an electro-optic coefficient characterizing the material. In an embodiment, the layer 20 may be comprised of a crystalline electro-optic material that lacks inversion symmetry and that is characterized by an optic axis whose refractive index is controllable by an applied electric field. In an embodiment, the electro-optic material may be lithium niobate. In alternative embodiments, the electro-optic material may be lithium tantalate, lithium niobate doped with magnesium oxide, or barium titanate. In alternative embodiments, the electro-optic material may be a binary or ternary III-V compound semiconductor material, such as gallium nitride, indium gallium nitride, indium phosphide, indium gallium arsenide, gallium arsenide, indium arsenide, or indium gallium phosphide.

The layer 20 is offset in a lateral direction from the waveguide core 12 and the layer 20 is also offset in a lateral direction from the waveguide core 14. The layer 20 may extend lengthwise along a longitudinal axis 21 that may be aligned parallel to the longitudinal axes 13, 15 of the waveguide cores 12, 14. In an embodiment, the layer 20 may have a width dimension W2 that is less than the width dimension W1 of the gap between the waveguide core 12 and the waveguide core 14. In an alternative embodiment, the width dimension W2 of the layer 20 may be equal to the width dimension W1 of the gap between the waveguide core 12 and the waveguide core 14. In an alternative embodiment, the width dimension W2 of the layer 20 may be greater than the width dimension W1 of the gap between the waveguide core 12 and the waveguide core 14. In an embodiment, the layer 20 may have a thickness in a direction perpendicular to the width dimension W2 that is approximately equal to the thickness of the waveguide cores 12, 14.

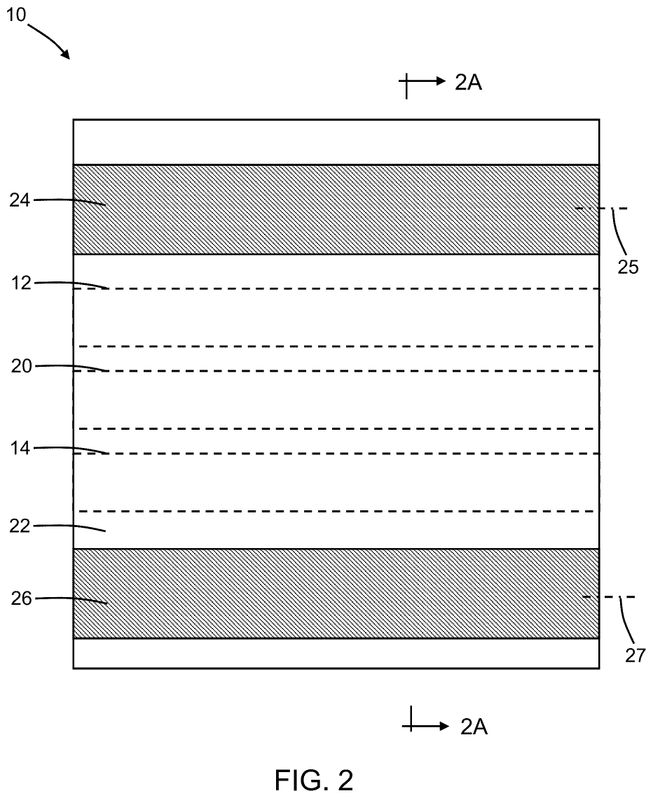

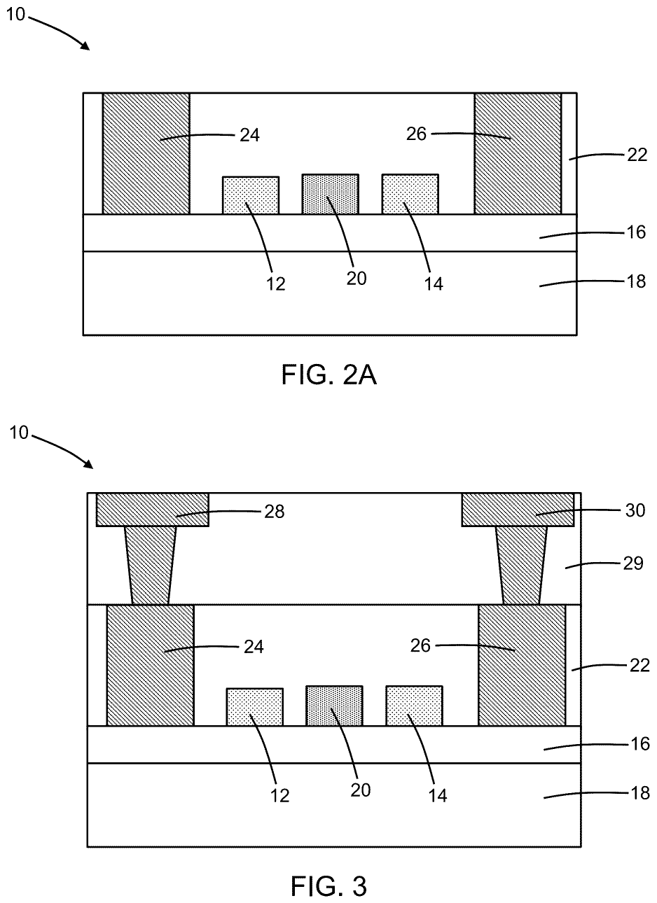

With reference to FIGS. 2, 2A in which like reference numerals refer to like features in FIGS. 1, 1A and at a subsequent fabrication stage, a dielectric layer 22 may be formed over the waveguide cores 12, 14 and the layer 20. The dielectric layer 22 may be comprised of a dielectric material, such as a stoichiometric or non-stoichiometric oxide including silicon (e.g., silicon dioxide), having a refractive index that is less than the refractive index of the material constituting the waveguide cores 12, 14 and, optionally, the material of the layer 20.

A metal layer 24 and a metal layer 26 may be formed that extend fully through the dielectric layer 22. In an embodiment, the metal layers 24, 26 may penetrate fully through the dielectric layer 22 to the dielectric layer 16. The metal layers 24, 26 may be positioned in respective openings that are patterned in the dielectric layer 22 by lithography and etching processes. The metal layer 24 may have a longitudinal axis 25, the metal layer 26 may have a longitudinal axis 27, and the longitudinal axes 25, 27 may be aligned parallel to the longitudinal axes 13, 15 of the waveguide cores 12, 14 and/or parallel to the longitudinal axis 21 of the layer 20. The metal layer 24 is positioned in a lateral direction adjacent to the waveguide core 12 and the metal layer 26 is positioned in a lateral direction adjacent to the waveguide core 14. The layer 20 and both of the waveguide cores 12, 14 are positioned in a lateral direction between the metal layer 24 and the metal layer 26 such that the waveguide core 12 is laterally positioned between the layer 20 and the metal layer 24 and the waveguide core 14 is laterally positioned between the layer 20 and the metal layer 26.

In an embodiment, the metal layers 24, 24 may be comprised of a metal, such as copper or aluminum, that is employed in back-end-of-line processing. In an alternative embodiment, the metal layers 24, 26 may be comprised of a noble metal, such as gold.

Portions of the dielectric material of the dielectric layer 22 separate the metal layer 24 from the waveguide core 12 and the metal layer 24 from the waveguide core 14, thereby preventing direct contact therebetween. Portions of the dielectric material of the dielectric layer 22 may also reside in the portions of the gap between the layer 20 and each of the waveguide cores 12, 14. In an alternative embodiment, a sealed undercut may be formed beneath all or a portion of the structure 10.

With reference to FIG. 3 in which like reference numerals refer to like features in FIGS. 2, 2A and at a subsequent fabrication stage, interconnects 28, 30 may be formed in one or more dielectric layers 29 that are respectively coupled by contacts to the metal layers 24, 26. The interconnects 28, 30 may be comprised of a metal, such as copper or aluminum, and the one or more dielectric layers 29 may be comprised of an electrical insulator, such as a stoichiometric or non-stoichiometric oxide including silicon (e.g., silicon dioxide). In an embodiment, the interconnects 28, 30 may be used to apply a modulated electric field to the layer 20 that induces the Pockels effect in the electro-optic material of the layer 20 and causes the refractive index of the material to vary in proportional to the strength of the applied electric field according to an electro-optic coefficient characterizing the material. The variation in the refractive index of the electro-optic material of the layer 20 may be used to modulate light being guided by the waveguide cores 12, 14 and metal layers 24, 26. For example, the modulated electric field may be used to generate a binary optical data stream.

The combination of the waveguide cores 12, 14, the layer 20, the metal layers 24, 26, and the intervening dielectric material of the dielectric layer 22 are consolidated into a hybrid plasmonic waveguide structure featuring a balance between optical confinement and propagation loss. In that regard, the metal layers 24, 26 may assist with the optical confinement of the light in the waveguide cores 12, 14, and the layer 20 may be employed to modulate the confined light.

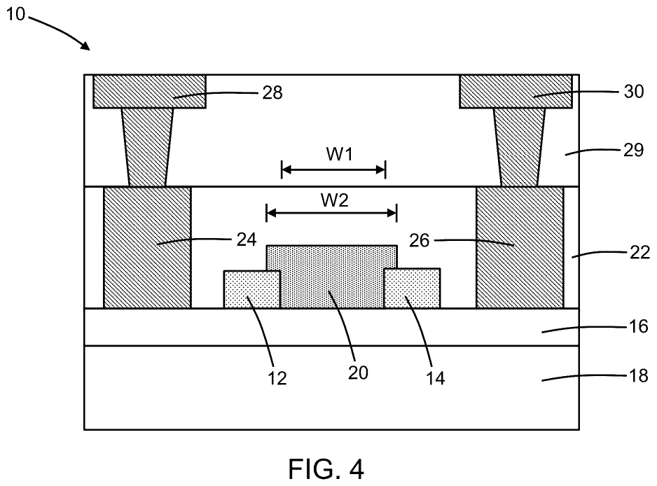

With reference to FIG. 4 and in accordance with alternative embodiments, the width dimension W2 of the layer 20 may be greater than the width dimension W1 of the gap between the waveguide core 12 and the waveguide core 14. As a consequence, a side edge portion of the layer 20 overlaps with the adjacent portion of the waveguide core 12 and another side edge portion of the layer 20 overlaps with the adjacent portion of the waveguide core 14.

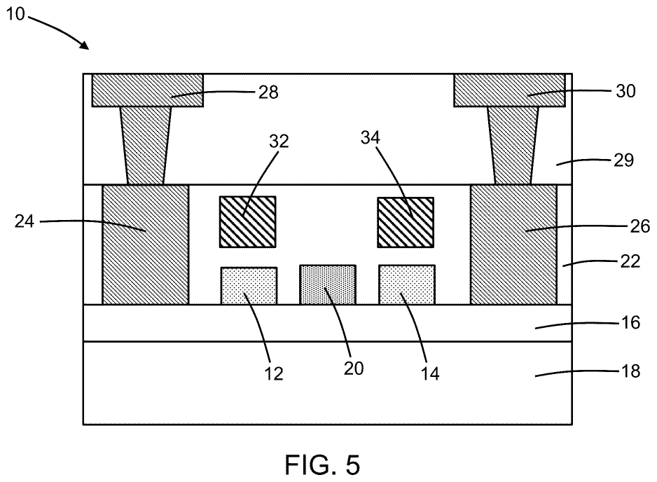

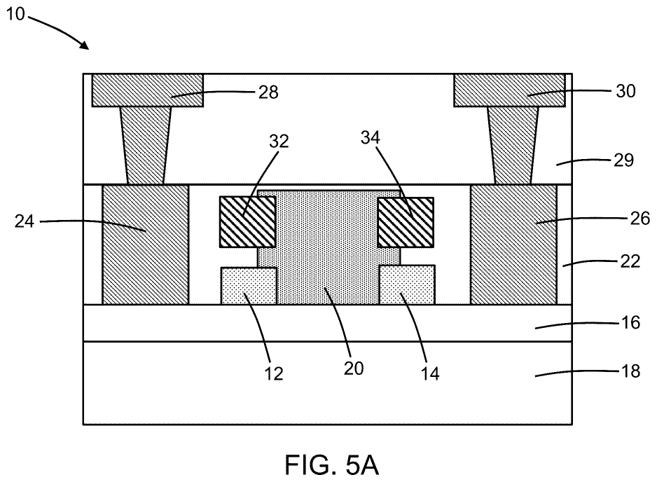

With reference to FIGS. 5, 5A and in accordance with alternative embodiments, a waveguide core 32 may be stacked with the waveguide core 12, and a waveguide core 34 may be stacked with the waveguide core 14. The waveguide core 32 overlaps with the waveguide core 12, and the waveguide core 34 overlaps with the waveguide core 14. In an embodiment, the waveguide cores 32, 34 may be comprised of a different material than the waveguide cores 12, 14. In an embodiment, the waveguide cores 32, 34 may be comprised of silicon nitride and the waveguide cores 12, 14 may be comprised of silicon.

In an alternative embodiment and as shown in FIG. 5A, the opposite side edge portions of the layer 20 may overlap with the waveguide cores 32, 34, as well as overlap with the waveguide cores 12, 14. In an embodiment, the material of the layer 20 may be disposed in a portion of the space between the waveguide core 32 and the waveguide core 12, as well as in a portion of the space between the waveguide core 34 and the waveguide core 14.

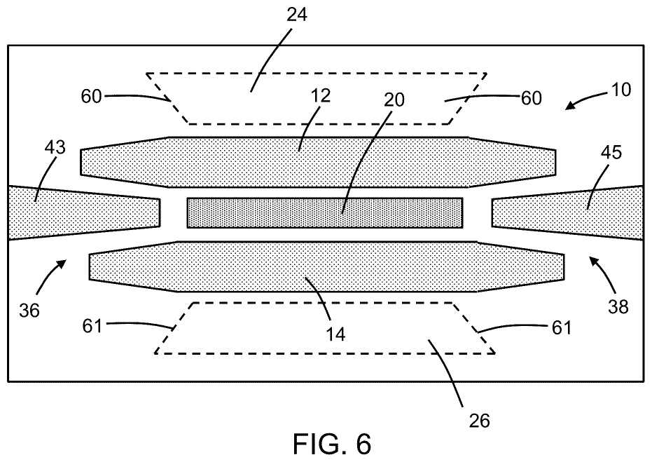

With reference to FIG. 6 and in accordance with alternative embodiments, the waveguide cores 12, 14 may be truncated with tapered sections at one end that participate in an input optical coupler 36 and tapered sections at an opposite end that participate in an output optical coupler 38. An input waveguide core 43 includes a tapered section that participates in the input optical coupler 36 such that arriving light is split between the waveguide core 12 and the waveguide core 14. An output waveguide core 45 includes a tapered section that participates in the input optical coupler 36 such that light received from the waveguide cores 12, 14 is combined.

The metal layer 24 may include chamfered ends 60 adjacent to the input optical coupler 36 and the output optical coupler 38. The metal layer 26 may include chamfered ends 61 adjacent to the input optical coupler 36 and the output optical coupler 38. The chamfered ends 60 are angled relative to the longitudinal axis 25 (FIG. 2), and the chamfered ends 61 are angled relative to the respective longitudinal axis 27 (FIG. 2). The chamfered ends 60, 61 may function to reduce optical return loss.

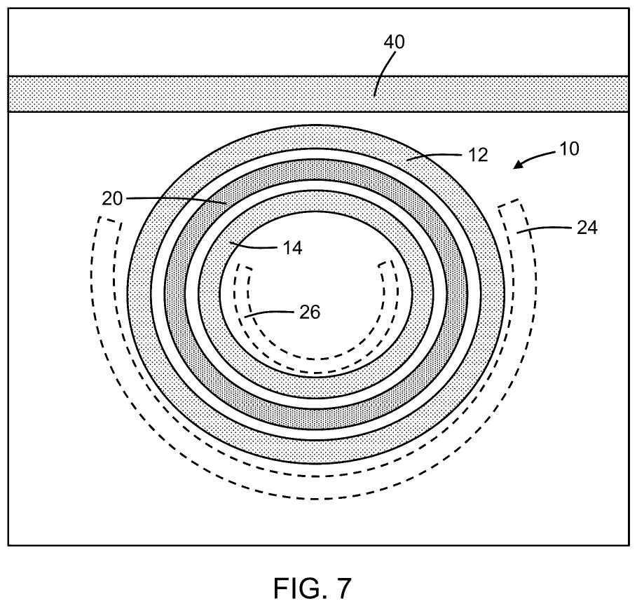

With reference to FIG. 7 and in accordance with alternative embodiments, the hybrid plasmonic waveguide embodied in the structure 10 may be integrated into a micro-ring modulator. The waveguide cores 12, 14 and the layer 20 may be shaped as concentric rings, the metal layer 24 may be shaped as an arc that is surrounded by the waveguide core 14, and the metal layer 26 may be shaped as an arc that surrounds a portion of the waveguide core 12.

A bus waveguide core 40 is routed proximate to a portion of the waveguide core 12 and participates in light coupling with the micro-ring modulator. In the representative embodiment, the bus waveguide core 40 may be linear such that a straight portion is routed proximate to a portion of the waveguide core 12. In an alternative embodiment, the bus waveguide core 40 may include a bend proximate to the micro-ring modulator that brings the routing of the bus waveguide core 40 into closer proximity with a portion of the waveguide core 12. In an alternative embodiment, the micro-ring modulator may have an oblong or racetrack shape with the waveguide core 12 having a straight portion adjacent to a portion of the bus waveguide core 40.

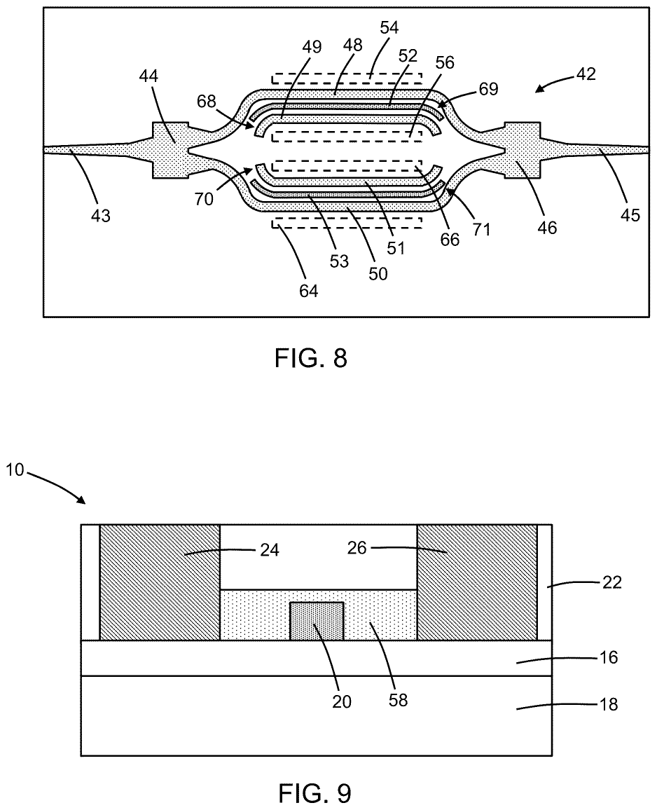

With reference to FIG. 8 and in accordance with alternative embodiments, a Mach-Zehnder interferometer 42 includes an input optical coupler 44, an output optical coupler 46, and waveguide cores 48, 50 representing arms that are separately routed from the input optical coupler 44 to the output optical coupler 46. An input waveguide core 43 is coupled to the input optical coupler 44, and an output waveguide core 45 coupled to the output optical coupler 46.

Each of the arms of the Mach-Zehnder interferometer 42 may integrate a hybrid plasmonic waveguide structure similar, or identical, to the hybrid plasmonic waveguide structure embodied in the structure 10. One arm of the Mach-Zehnder interferometer 42 may include a truncated waveguide core 49, a truncated layer 52 that is positioned in a lateral direction between the waveguide core 48 and the truncated waveguide core 49, and subsequently-formed metal layers 54, 56 that are also truncated. The other arm of the Mach-Zehnder interferometer 42 may include a truncated waveguide core 51, a truncated layer 53 that is positioned in a lateral direction between the waveguide core 50 and the truncated waveguide core 51, and subsequently-formed metal layers 64, 66 that are also truncated.

The truncated waveguide core 49 and the truncated layer 52 may have end portions represented by bends 68, 69 that provide adiabatic transitions. One of the bends 68 of the truncated waveguide core 49 may be positioned adjacent to the input optical coupler 44, and the other of the bends 68 of the truncated waveguide core 49 may be positioned adjacent to the output optical coupler 46. One of the bends 69 of the truncated layer 52 may be positioned adjacent to the input optical coupler 44, and the other of the bends 69 of the truncated layer 52 may be positioned adjacent to the output optical coupler 46.

The truncated waveguide core 51 and the truncated layer 53 may have end portions represented by bends 70, 71 that provide adiabatic transitions. One of the bends 70 of the truncated waveguide core 51 may be positioned adjacent to the input optical coupler 44, and the other of the bends 70 of the truncated waveguide core 51 may be positioned adjacent to the output optical coupler 46. One of the bends 71 of the truncated layer 53 may be positioned adjacent to the input optical coupler 44, and the other of the bends 71 of the truncated layer 53 may be positioned adjacent to the output optical coupler 46.

The waveguide cores 48, 50 and the truncated waveguide cores 49, 51 may be comprised of the same material as the waveguide cores 12, 14. The truncated layers 52, 53 may be comprised of the same electro-active material as the layer 20. The metal layers 54, 56 and the metal layers 64, 66 may be comprised of the same metal as the metal layers 24, 26.

The hybrid plasmonic waveguide structures may be used to generate a phase difference between the light propagating in the different arms of the Mach-Zehnder interferometer 42 for generating a modulated light signal at the output port from the output optical coupler 46. The modulation may be achieved by applying an electrical signal to the electro-optic material of the truncated layers 52, 53 embedded in the hybrid plasmonic waveguide structures.

With reference to FIG. 9 and in accordance with alternative embodiments, the waveguide cores 12, 14 may be omitted from the structure 10. The layer 20 may be positioned in a gap laterally between the metal layer 24 and the metal layer 26, and the layer 20 may have a non-contacting relationship with each of the metal layers 24, 26. A layer 58 may be formed that coats the layer 20 and that is disposed in the spaces between the layer 20 and the metal layers 24, 26. The layer 58 may be comprised of an electrical insulator, such as aluminum oxide or a stoichiometric or non-stoichiometric oxide including silicon (e.g., silicon dioxide), having a lower refractive index than the material constituting the layer 20. The material of the layer 58 provides index contrast with the material of the layer 20 such that the layer 20 can function as a waveguide core capable of guiding light.

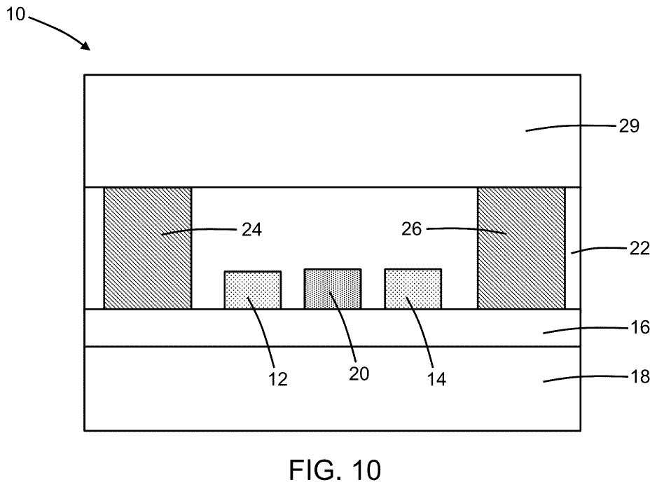

With reference to FIG. 10 and in accordance with alternative embodiments, the interconnects 28, 30 may be omitted from the structure 10. The hybrid plasmonic waveguide structure includes the waveguide cores 12, 14, the layer 20, and the metal layers 24, 26.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/-10% of the stated value(s) or the stated condition(s).

References herein to terms such as “vertical”, “horizontal”, etc. are made by way of example, and not by way of limitation, to establish a frame of reference. The term “horizontal” as used herein is defined as a direction or a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a photonic chip, the structure comprising:
a first waveguide core;
a second waveguide core adjacent to the first waveguide core;
a first layer between the first waveguide core and the second waveguide core, the first layer comprising an electro-optic material;
a second layer adjacent to the first waveguide core; and
a third layer adjacent to the second waveguide core,
wherein the second layer and the third layer comprise a metal.

2. The structure of claim 1 wherein the first waveguide core is positioned in a lateral direction between the first layer and the second layer, and the second waveguide core is positioned in the lateral direction between the first layer and the third layer.

3. The structure of claim 1 wherein the second layer is positioned in a lateral direction between the first layer and the first waveguide core, and the third layer is positioned in the lateral direction between the first layer and the second waveguide core.

4. The structure of claim 1 further comprising:
a substrate;
a first dielectric layer on the substrate; and
a second dielectric layer over the first dielectric layer,
wherein the first waveguide core, the second waveguide core, and the first layer are positioned on the first dielectric layer, and the second layer and the third layer extend fully through the second dielectric layer to the first dielectric layer.

5. The structure of claim 1 wherein the electro-optic material is lithium niobate, lithium tantalate, lithium niobate doped with magnesium oxide, or barium titanate.

6. The structure of claim 5 wherein the metal comprises copper or aluminum.

7. The structure of claim 5 wherein the first waveguide core and the second waveguide core comprise silicon.

8. The structure of claim 1 wherein the electro-optic material is a III-V compound semiconductor.

9. The structure of claim 1 wherein the first layer has a partially overlapping relationship with the first waveguide core, and the first layer has a partially overlapping relationship with the second waveguide core.

10. The structure of claim 1 wherein the second waveguide core is separated from the first waveguide core by a gap, the first layer is positioned in the gap between the first waveguide core and the second waveguide core, and further comprising:
a dielectric layer comprising a dielectric material, the dielectric layer including a first portion in the gap between the first waveguide core and the first layer and a second portion in the gap between the second waveguide core and the first layer.

11. The structure of claim 1 further comprising:
a third waveguide core that overlaps with the first waveguide core; and
a fourth waveguide core that overlaps with the second waveguide core.

12. The structure of claim 11 wherein the first waveguide core and the second waveguide core comprise a first material, and the third waveguide core and the fourth waveguide core comprise a second material different from the first material.

13. The structure of claim 11 wherein the first layer overlaps with the first waveguide core, the second waveguide core, the third waveguide core, and the fourth waveguide core.

14. The structure of claim 1 further comprising:
a first optical coupler; and
a second optical coupler,
wherein the first waveguide core extends from the first optical coupler to the second optical coupler.

15. The structure of claim 14 wherein the second layer has a chamfered end adjacent to the first optical coupler, and the third layer has a chamfered end adjacent to the first optical coupler.

16. The structure of claim 14 wherein the third layer is truncated by a bend adjacent to the first optical coupler.

17. The structure of claim 14 further comprising:
a third waveguide core that extends from the first optical coupler to the second optical coupler.

18. A structure for a photonic chip, the structure comprising:
a first layer comprising a metal;
a second layer adjacent to the first layer, the second layer comprising the metal; and
a third layer between the first layer and the second layer, the third layer comprising an electro-optic material, and the third layer having respective non-contacting relationships with the first layer and the second layer.

19. The structure of claim 18 further comprising:
a dielectric layer including a first portion between the third layer and the first layer and a second portion between the third layer and the second layer, the dielectric layer comprised of a material having a higher refractive index than the electro-optic material.

20. A method of forming a structure for a photonic chip, the method comprising:
forming a first waveguide core and a second waveguide core adjacent to the first waveguide core;
forming a first layer between the first waveguide core and the second waveguide core, wherein the first layer comprises an electro-optic material; and
forming a second layer adjacent to the first waveguide core and a third layer adjacent to the second waveguide core, wherein the second layer and the third layer comprise a metal.
